(19) United States
(12) Patent Application Publication
(10) Pub. No.: US 2025/0388402 A1
(43) Pub. Date: Dec. 25, 2025

(54) MULTI-STAGE METHOD FOR AUTOMATICALLY SEQUENCING GOODS, AND ORDERPICKING SYSTEM FOR SAME

(71) Applicant: TGW Logistics GmbH, Marchtrenk (AT)

(72) Inventor: Gerhard MESSNER, Linz (AT)

(73) Assignee: TGW Logistics GmbH, Marchtrenk (AT)

(21) Appl. No.: 18/879,208

(22) PCT Filed: Jun. 28, 2023
(86) PCT No.: PCT/AT2023/060204

§ 371 Date: Dec. 26, 2024

(30) Foreign Application Priority Data
Jun. 30, 2022 (AT) A 50477/2022

(51) Int. Cl. B65G 1/137

(52) U.S. Cl. CPC B65G 1/1376; B65G 1/1378

(57) ABSTRACT

A multi-stage system and method for sequencing articles in a picking system comprises a first sorting device with multiple buffer conveyor lines which are parallel in terms of conveyance and a downstream second sorting device. Acquired orders are lined up in a control computer of the picking system and subsequently segmented into article groups with a specifiable number of articles each, independent of order boundaries. For the sorting operation, article groups are selectively stored in the buffer conveyor lines and are subsequently conveyed to the second sorting device, where they are sorted, article group by article group, according to the order sequence.

### BACKGROUND OF THE DISCLOSURE

The disclosure relates to a picking system with a storage area in which articles are stored and which comprises a retrieval conveying system with a first sorting device, with a second sorting device which is arranged downstream of the first sorting device and with a picking area which is arranged downstream of the second sorting device. The first sorting device comprises multiple buffer conveyor lines arranged in parallel in terms of conveyance and an input-side handover device assigned per buffer conveyor line and an output-side handover device assigned per buffer conveyor line. The picking system additionally comprises a first conveying system, which connects the storage area and the first sorting device, a second conveying system, which connects the first sorting device and the second sorting device, and a third conveying system, which connects the second sorting device and the picking area. In addition, the picking system has a control system which comprises a control computer and which is connected to the first sorting device and second sorting device. Further, the disclosure relates to a method for operating said picking system in order to automatically bring articles in a specifiable sequence.

A picking system and a method of said kind are generally known from the prior art. For example, EP 2 560 899 B1 discloses, in this context, a picking plant and a method for picking packaged items with a removal device for removing packaged items from a warehouse, a buffer device for buffering the removed packaged items and a dispensing device, by means of which buffered packaged items can be withdrawn from the buffer device according to a particular picking order. The buffer device can have at least one collecting conveyor, on which the buffered packaged items are collected.

What is disadvantageous about EP 2 560 899 B1 and other known systems for automatically sequencing articles is that the devices required for forming a specified sequence of the articles in a picking system are very expensive yet operated inefficiently.

It is therefore an object of the disclosure to specify an improved method for automatically sequencing articles, and an improved picking system. In particular, devices required for forming a specified sequence of the articles in a picking system are to be operated efficiently.

### Overview

To achieve said object, a multi-stage method for automatically sequencing articles in a picking system of the kind mentioned in the beginning with the following steps is proposed:
a) acquiring multiple orders, each of which comprises at least one article, in the control computer,
b) forming an order sequence of the orders desired in the picking area and an article sequence of the articles within each order of the orders in the control computer,
c) forming an overall article sequence by lining up the orders in accordance with the desired order sequence in the control computer,
d) segmenting the overall article sequence into article groups with a specifiable number of articles each, independent of order boundaries, and forming a group sequence of the article groups according to the overall article sequence in the control computer, wherein the number of the articles in an article group corresponds to maximally the number of the articles which can be brought into any sequence in the second sorting device,
e) forming a retrieval group, which comprises article groups of the group sequence sorted in ascending order for whose articles free capacity will be available in the first sorting device upon a handover into the first sorting device, in the control computer,
f) retrieving the articles comprised by the retrieval group from the storage area using the retrieval conveying system,
g) conveying the articles comprised by the retrieval group to the first sorting device using the first conveying system,
h) selectively handing over the articles of the retrieval group from the first conveying system onto the buffer conveyor lines using the input-side handover devices, wherein articles of an article group of the retrieval group are handed over into a vacant buffer area onto at least one of the buffer conveyor lines and wherein the articles of the article group in the at least one buffer conveyor line are arranged directly adjacent to one another in any sequence,
i) handing over the articles of the article groups handed over to the buffer conveyor lines from the buffer conveyor lines to the second conveying system in the group sequence using the output-side handover devices,
j) transporting the articles of the article groups to the second sorting device in the group sequence using the second conveying system,
k) sorting the articles groupwise, article group by article group, according to the order sequence in the second sorting device,
l) transporting the articles from the second sorting device into the picking area in the order sequence using the third conveying system, and
m) reloading the articles into or onto target loading aids in accordance with the acquired orders in the picking area.

In the same manner, said object is achieved by a picking system of the kind mentioned in the beginning, in which the control computer of the control system is configured for:
a) acquiring multiple orders, each of which comprises at least one article,
b) forming an order sequence of the orders desired in the picking area and an article sequence of the articles within each order of the orders,
c) forming an overall article sequence by lining up the orders in accordance with the desired order sequence,
d) segmenting the overall article sequence into article groups with a specifiable number of articles each, independent of order boundaries, and forming a group sequence of the article groups corresponding to the overall article sequence, wherein the number of the articles in an article group corresponds to maximally the number of the articles which can be brought into any sequence in the second sorting device,
e) forming a retrieval group, which comprises article groups of the group sequence sorted in ascending order for whose articles free capacity will be available in the first sorting device upon a handover into the first sorting device,
f) triggering a retrieval of the articles comprised by the retrieval group from the storage area using the retrieval conveying system,
g) triggering a conveyance of the articles comprised by the retrieval group to the first sorting device using the first conveying system,
h) triggering a selective handover of the articles of the retrieval group from the first conveying system onto the buffer conveyor lines using the input-side handover devices, wherein articles of an article group of the retrieval group are handed over into a vacant buffer area onto at least one of the buffer conveyor lines and wherein the articles of the article group in the at least one buffer conveyor line are arranged directly adjacent to one another in any sequence,
i) triggering a handover of the articles of the article groups handed over to the buffer conveyor lines from the buffer conveyor lines to the second conveying system in the group sequence using the output-side handover devices,
j) triggering a transport of the articles of the article groups to the second sorting device in the group sequence using the second conveying system,
k) triggering a groupwise sorting of the articles, article group by article group, according to the order sequence in the second sorting device,
l) triggering a transport of the articles from the second sorting device into the picking area in the order sequence using the third conveying system, and
m) triggering a reloading of the articles into or onto target loading aids in accordance with the acquired orders in the picking area.

The technical effect of the segmentation of the overall article sequence into article groups with any number of articles each, independent of order boundaries, is in particular that the second sorting device can be operated in an optimized manner, i.e. close to or at the maximum sorting capacity. In the given context, “in an optimized manner” means in particular that an article group can be defined such that the number of the articles comprised by it corresponds to precisely the number of the articles which can be brought into any sequence in the second sorting device in a (single) sorting operation. “In an optimized manner” means in particular also that a retrieval group can be formed in step e) which comprises those of the article groups of the group sequence sorted in ascending order for whose articles free capacity will be available in the first sorting device upon a handover into the first sorting device.

A dissociation from order boundaries and a segmentation of the overall article sequence independent of order boundaries therefore enable both the first sorting device and the second sorting device to be operated in an optimized manner. This means that their efficiency compared to the prior art can be increased. In the order-by-order processing known from the prior art, sorting devices, having to be designed for accommodating the largest possible order, are too big for the plurality of the other cases and are therefore operated only inefficiently.

Within the meaning of this disclosure, an “order” can be assigned, for example, to a customer and therefore form a “customer order.” The articles of this customer order may occupy one dispatch loading aid, multiple dispatch loading aids or also only a part of a dispatch loading aid (for example when articles of multiple customer orders are combined on a pallet). Yet, an “order” can also be assigned to a dispatch loading aid and therefore comprise articles which are to be loaded into or onto this dispatch loading aid. Such an order can comprise articles of one or multiple customers.

The order sequence formed in step b) and desired in the picking area does not necessarily correspond to the sequence in which the orders were received but can be determined according to a priority of the orders or on the basis of a point in time at which an order must be completed (i.e. for example on the basis of a delivery date). The article sequence can be an article sequence desired in the picking area, but this is not imperative. In one variant of the proposed method and/or picking system, no specific article sequence within an order is demanded in the picking area. The specification “linking together the orders” can generally also be used synonymously to the term “lining up the orders.” An article group can comprise articles of one or multiple orders. The articles of an order can be comprised by one or multiple article groups.

The retrieval conveying system can in particular comprise storage and retrieval units (single-level storage and retrieval units or multi-level storage and retrieval units), as well as shuttles in one or multiple rack aisles. The procedure proposed above enables, in step f), also the chaotic retrieval of articles. The retrieval performance of the retrieval conveying system can thereby be optimized, for example when the articles are lined up with regard to a time-optimized or route-optimized operation of storage and retrieval units or shuttles of the retrieval conveying system.

“In parallel in terms of conveyance” or “parallel in the sense of a flow of conveyed articles” does not necessarily mean “geometrically parallel” but merely that a flow of conveyed articles divides into multiple parallel flows of conveyed articles (which extend through the buffer conveyor lines in the present case). The buffer conveyor lines can but do not have to be arranged so as to extend geometrically in parallel. The buffer conveyor lines can all have the same length and receive the same number of articles, yet they can also have different lengths and receive different numbers of articles.

The input-side handover device can be formed by an infeed device arranged along the first conveying device, for example by a roller switch, a belt offset or a pushing device (pusher). The output-side handover device can be formed by an outfeed device arranged along the second conveying device, for example by conveyor rollers of the buffer conveyor line, a roller switch or a belt offset.

The specification “articles of an article group arranged directly adjacent to one another” means in particular that the articles of the respective article group are arranged so as not to be mixed with articles of another article group (provided that a buffer conveyor line is provided for receiving multiple article groups at all).

The forming of a retrieval group in step e) can be executed once corresponding capacity is actually available in the first sorting device or also in a predictive or proactive manner if corresponding capacity will (presumably) be available in the first sorting device upon a handover of the articles of the retrieval group into the first sorting device.

The picking area can in particular have a manually and/or automatically operated picking station. The loading of the articles into or onto target loading aids in step m) can be executed manually or with a loading system. In case of the manual loading, it is indicated to the respective worker, in particular automatically, which articles he is to place into or onto a dispatch loading aid. A corresponding output can be optical (e.g. via a screen, indicator lamps or data goggles) and/or acoustic (e.g. via a loudspeaker or set of headphones). The loading system can also have one or multiple loading robots for the automatic loading. In step m), one or multiple target loading aids, e.g. one or multiple dispatch loading aids, can be provided per order.

In addition to the control computer, the “control system” can have other components which are required for executing the proposed method. For example, these can be data lines or radio links between the control computer and the actuators provided in the picking system, i.e. for example data lines or radio links between the control computer and the retrieval conveying system, the first sorting device, the first conveying system, the second sorting device, the second conveying system, the picking area and the third conveying system. Steps f) to m) can be initiated by the control computer. The control of these steps f) to m) can then be taken over, for example, by a local subcontroller, for example a subcontroller of the retrieval conveying system, a subcontroller of the first sorting device, a subcontroller of the first conveying system, a subcontroller of the second sorting device, a subcontroller of the second conveying system, a subcontroller of the picking area or a subcontroller of the third conveying system. Yet, steps f) to m) can also be controlled directly by the control computer. A local subcontroller is then not necessary. Also mixed forms are conceivable in which some of the steps f) to m) are initiated by the control computer and others of the steps f) to m) are directly controlled by the control computer.

The articles can be conveyed continuously or discontinuously using the first conveying system, using the second conveying system and using the third conveying system. In case of the discontinuous conveyance, the articles can be backed up using the first conveying system, using the second conveying system and/or using the third conveying system. The first conveying system, the second conveying system and/or the third conveying system can therefore act as a buffer, temporarily or in sections.

Generally, the sorting in the method presented and/or in the picking system presented is executed in two stages, with further sorting stages being possible. Strictly speaking, a presorting in the first sorting stage can only be executed if at least one retrieval group comprises more than one article group. In particular, it is therefore of advantage if a retrieval group comprises multiple article groups or if all retrieval groups comprise more than one article group.

Further advantageous designs and further advancements of the disclosure result from the subclaims as well as from the description in combination with the figures.

It is advantageous if article groups which contain articles of respectively only one order pass through the second sorting device in step k) without a sorting operation or avoid it using a bypass. This ensures that the second sorting device is not unnecessarily burdened when no particular article sequence within an order is demanded in the picking area. The second sorting device can therefore be operated even more efficiently.

Yet, it is also favorable if:
an article sequence of the articles desired in the picking area is additionally formed within each order of the orders in the control computer in step b),
an overall article sequence desired in the picking area is formed by lining up the orders in step c),
the overall article sequence is produced by sorting the articles groupwise, article group by article group, in the sorting device in step k), and
the articles are transported into the picking area in the overall article sequence with the third conveying system in step l).

In this embodiment variant, an article sequence of the articles within an order desired in the picking area is therefore produced. In this embodiment variant, the order-by-order grouping of the articles according to the order sequence is executed implicitly by producing the desired overall article sequence. An explicit step for grouping the articles order by order according to the order sequence is not required to that end.

It is further advantageous for each article group to have the same number of articles. This enables the segmentation of the overall article sequence in step d) to be executed in a simple manner. This procedure is particularly recommended whenever all buffer conveyor lines have the same length and/or can receive the same number of articles.

It is particularly advantageous if the number of articles in an article group corresponds to precisely the number of articles which can be brought into any sequence in the second sorting device in a (single) sorting operation. This enables the second sorting device to be operated at the maximum sorting capacity and therefore particularly efficiently.

It is favorable if the articles of an article group of the retrieval group are stored in a vacant area of precisely one of the buffer conveyor lines. In this manner, it is avoided that the articles of an article group are stored across multiple buffer conveyor lines. This simplifies the procedure during the sorting in the first sorting stage.

It is further advantageous if each of the buffer conveyor lines receives articles of precisely one article group. This, too, simplifies the procedure during the sorting in the first sorting stage.

It is particularly advantageous in the above case if the retrieval of the articles comprised by the retrieval group in step f) is executed in chaotic sequence. This enables the retrieval performance of the retrieval conveying system to be optimized.

It is further advantageous if each of the buffer conveyor lines receives articles of multiple whole article groups, wherein the article groups have an ordinal number corresponding to the group sequence and wherein articles of article groups with a lower ordinal number are stored further downstream in the respective buffer line than articles of article groups with a higher ordinal number. In this case, a buffer conveyor line can also receive articles from two, three or more article groups. The proposed measures ensure that a demanded form factor for the first sorting device is achieved more easily. In addition, a constant flow of conveyed articles at the output of the first sorting device can be upheld even if a conveyance of additional articles into the first sorting device takes a relatively long time.

In another embodiment variant, it can be provided that the articles of some of the article groups of the retrieval group are stored in vacant areas of multiple of the buffer conveyor lines. This enables better use to be made of the buffer conveyor lines under certain circumstances. This is true in particular if a quotient of an article capacity of a buffer conveyor line of the buffer conveyor lines and the number of the articles in an article group is not integral, wherein the article groups have an ordinal number corresponding to the group sequence and wherein articles of article groups with a lower ordinal number are stored further downstream in the respective buffer line than articles of article groups with a higher ordinal number. In this case, fewer or more articles are therefore stored in a buffer conveyor line than are comprised by an integral number of article groups.

If more than one article group is stored or can be stored in a buffer conveyor line, it is of advantage if the retrieval of the articles comprised by the retrieval group in step f) is executed in chaotic sequence, wherein articles of those article groups which are handed over to one of the buffer conveyor lines in succession in step h) are retrieved in accordance with the group sequence. In this variant, the principle of the chaotic retrieval of the articles is broken in that article groups which are located in succession in a buffer conveyor line can be retrieved without violating the group sequence. Otherwise, the chaotic retrieval principle will take effect. This means that the articles of a first article group which is stored further downstream in a buffer conveyor line are retrieved from the storage area before articles of a second article group which is stored further upstream in the buffer conveyor line. Yet, within the two article groups, the articles can respectively be present and/or retrieved in chaotic sequence. It is even possible for articles of other, third article groups to be mixed with the articles of the first and second article groups.

If more than one article group is stored or can be stored in a buffer conveyor line, it is alternatively also of advantage if the retrieval of the articles comprised by the retrieval group in step f) is executed in chaotic sequence, wherein a retrieval group in step e) has maximally (in particular precisely) as many article groups as buffer conveyor lines will have free capacity for receiving articles of one article group each upon a handover of the articles of the retrieval group into the first sorting device. Here, it is avoided a priori that a retrieval group has multiple article groups which are handed over in succession to a single buffer conveyor line. Therefore, a chaotic retrieval of articles can be performed without limitation in this case. An initial filling of the first sorting device can advantageously be executed gradually using multiple retrieval groups. In particular, precisely as many retrieval groups can be provided as article groups can be received in a (the longest) buffer conveyor line.

Generally, the method presented may refer to picking systems in which each of the articles consists of a single piece and/or the procedures presented can be based on one piece per article. Yet, this is not an imperative condition. Rather, it is also conceivable that
an article in the overall article sequence is any piece of multiple articles of the same type of article which are stored in or on a loading aid,
steps f) to l) are executed by corresponding manipulation of the loading aid, and
step m) comprises the removal of the article from or off the loading aid.

This means, therefore, that instead of an article also a loading aid with multiple pieces of the respective article can be provided in the method presented. Yet, this does basically not change the sorting method, in particular when respectively one piece of an article is removed from the respective loading aids. If multiple pieces of an article are required in step m), the method can be simplified in that simply multiple pieces of an article are removed from a loading aid without having to occupy multiple places in the article sequence to that end. Instead, the article sequence can have a multiplier at the corresponding place, which specifies how many pieces of the respective type of article are to be removed in step m). The specification may therefore be “3 pieces of type of article A.” However, it must be ensured that the respective loading aid then contains at least three pieces of the type of article A and three pieces of the type of article A are removed from or off the loading aid and reloaded into or onto the target loading aid in step m), as there may otherwise be disruptions in the picking procedure.

This case may be referred to as “type-of-article sequence” instead of “article sequence.” Accordingly, the term “article sequence” in the above disclosure can be mentally replaced with the term “type-of-article sequence.” Also conceivable are mixed forms in which a part of the articles are provided as one piece and manipulated without loading aids and another part of the articles are transported in loading aids. Accordingly, the term “article sequence” in the above disclosure can be mentally replaced with the term “mixed type-of-article and article sequence.”

However, it should be noted that the article sequence in each of the cases mentioned can have multiple instances of an article or type of article if multiple pieces of the article or type of article are required in different picking stations, or also in one picking station at different points in time. For example, this case may occur when multiple pieces of the respective article or type of article are required and/or provided in different places in a packing pattern for a pallet.

Advantageously, a remaining quantity of articles which remains in or on the loading aid after step m) can be stored in the storage area again. This enables the remaining quantity of articles to be made available for a later picking operation, for example if the remaining quantity of articles is requested again in a later order.

For the purpose of better understanding of the disclosure, it will be elucidated in more detail by means of the figures below.

### BRIEF DESCRIPTION OF THE FIGURES

The figures show in a respectively very simplified schematic representation:

FIG. 1 a first example of a picking system in a schematic representation;

FIG. 2 an exemplary order sequence of multiple lined up orders;

FIG. 3 an exemplary segmentation of the order sequence from FIG. 2 into multiple article groups;

FIG. 4 a retrieval group comprising multiple article groups;

FIG. 5 an exemplary and chaotic article sequence of the articles from FIG. 2 after the retrieval from the storage area;

FIG. 6 the picking system from FIG. 1 in a state in which some of the articles of the sequence from FIG. 5 have been handed over into the first sorting device;

FIG. 7 the picking system from FIG. 1 in a state in which all the articles of the sequence from FIG. 5 have been handed over into the first sorting device;

FIG. 8 an exemplary article sequence of the articles from FIG. 2 after the retrieval from the first sorting device;

FIG. 9 an exemplary second sorting device during the sorting of the second article group of the article sequence represented in FIG. 8;

FIG. 10 the second sorting device from FIG. 9 after the sorting of the second article group of the article sequence represented in FIG. 8;

FIG. 11 an exemplary article sequence of the articles from FIG. 2 after leaving the second sorting device;

FIG. 12 the picking system from FIG. 7 after two article groups have left the first sorting device again;

FIG. 13 an exemplary order sequence of other lined up orders;

FIG. 14 an exemplary segmentation of the order sequence from FIG. 13 into multiple article groups;

FIG. 15 a second retrieval group comprising multiple article groups;

FIG. 16 the picking system from FIG. 12 after two other article groups have been handed over to the first sorting device;

FIG. 17 an example of a picking system with buffer conveyor lines, each of which can receive two article groups;

FIG. 18 an example of a picking system with buffer conveyor lines, each of which can receive more than two article groups;

FIG. 19 like FIG. 17 but with a bypass for avoiding the second sorting device, and

FIG. 20 like FIG. 17 but with a return conveyor to the storage area.

### DETAILED DESCRIPTION OF THE EMBODIMENTS

In the different embodiments that are described, equal parts are provided with equal reference numbers and/or equal component designations, where the disclosure contained in the entire description may be analogously transferred to equal parts with equal reference numbers and/or equal component designations. Moreover, the specifications of location, such as at the top, at the bottom, at the side, chosen in the description refer to the directly described and depicted figure, and, in case of a change of position, are to be analogously transferred to the new position.

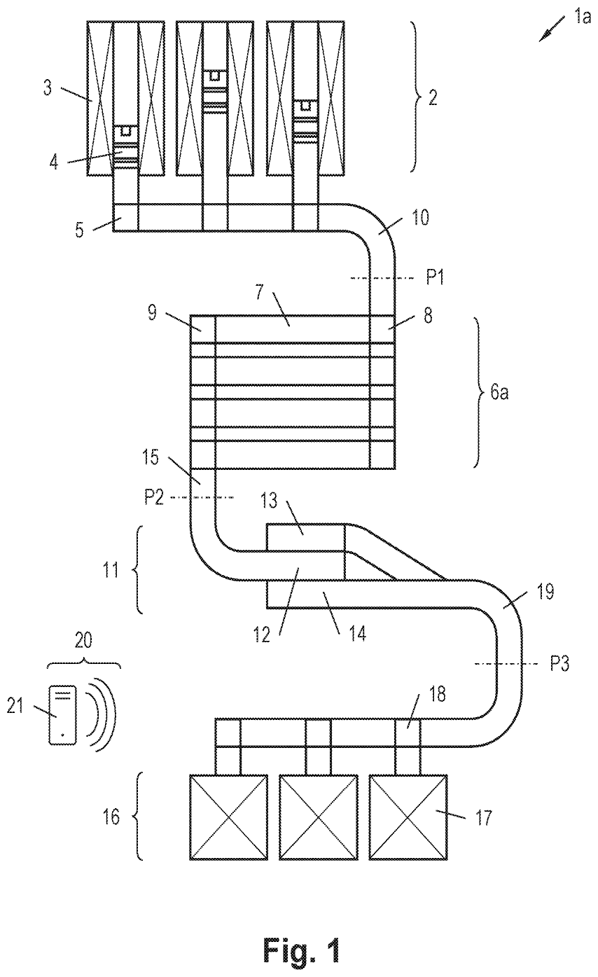

FIG. 1 shows a first example of a picking system 1a in a schematic representation. The picking system 1a comprises a storage area 2, which comprises multiple storage racks 3 and a retrieval conveying system 4 here. In the region of the storage area 2, also output-side handover devices 5 are arranged. In the storage racks 3, a plurality of articles not represented in FIG. 1 is stored during operation of the picking system 1a. Further, the picking system 1a comprises a first sorting device 6a, which has multiple buffer conveyor lines 7 which are parallel in terms of conveyance and an input-side handover device 8 assigned per buffer conveyor line 7 and an output-side handover device 9 assigned per buffer conveyor line 7. In addition, the picking system 1a comprises a first conveying system 10, which connects the storage area 2 and the first sorting device 6a. Furthermore, the picking system 1a comprises a second sorting device 11, which is arranged downstream of the first sorting device 6a. In this example, the second sorting device 11 comprises a central supply conveyor 12 and two removal conveyors 13 and 14 arranged laterally. The picking system 1a also comprises a second conveying system 15, which connects the first sorting device 6a and the second sorting device 11. Further, the picking system 1a comprises a picking area 16, which is arranged downstream of the second sorting device 11. The picking area 16 can have, for example, a manually and/or automatically operated picking station 17 or, as represented by way of example, multiple manually and/or automatically operated picking stations 17, as symbolically represented in FIG. 1. In the region of the picking stations 17, also input-side handover devices 18 are arranged. In addition, the picking system 1a comprises a third conveying system 19, which connects the second sorting device 6a and the picking area 16. Finally, the picking system 1a comprises a control system 20, which has a control computer 21 and which is connected at least to the first sorting device 6a and second sorting device 11.

The retrieval conveying system 4 can comprise, for example, multiple multi-level storage and retrieval units, single-level storage and retrieval units as well as shuttles and suchlike, which are moving between the storage racks 3. The retrieval conveying system 4 can be used to remove articles from the storage racks 3 and hand them over onto the first conveying system 10.

The first conveying system 10, the second conveying system 15, the third conveying system 19, buffer conveyor lines 7 of the first sorting device 6a, as well as the central supply conveyor 12 and the two laterally-arranged removal conveyors 13 and 14 of the second sorting device 11, can in particular be configured as or comprise roller conveyors. Alternatively or additionally, said units can also be formed by or comprise conveyor belts, chain conveyors and suchlike.

The output-side handover devices 5 in the region of the storage area 2 can be formed by outfeed devices arranged along the first conveying system 10, for example by conveyor rollers of a warehouse conveyor line adjoining the retrieval conveying system 4, a roller switch or a belt offset. The handover devices 5 can be used to hand over articles coming from the retrieval conveying system 4 to the first conveying system 10.

In this example, the buffer conveyor lines 7 extend in parallel both in terms of conveyance and geometrically. A mutually parallel alignment of the buffer conveyor lines 7 in the geometric sense, however, is not required. It is sufficient if a flow of conveyed articles coming from the first conveying system 10 divides or can divide into multiple parallel flows of conveyed articles extending through the buffer conveyor lines 7.

The input-side handover device 8 of the first sorting device 6a can be formed, for example, by an infeed device arranged along the first conveying system 10, for example by a roller switch, a belt offset or a pushing device (pusher). The handover devices 8 can be used to hand over articles coming from the first conveying system 10 onto the buffer conveyor lines 7 in a targeted manner. The output-side handover device of the first sorting device 6a can be formed by an outfeed device arranged along the second conveying system 15, for example by conveyor rollers of the buffer conveyor line 7, a roller switch or a belt offset. The handover devices 9 can be used to hand over articles coming from the buffer conveyor lines 7 onto the second conveying system 15.

The input-side handover device 18 in the region of the picking stations 17 can be formed, for example, by an infeed device arranged along the third conveying system 19, for example by a roller switch, a belt offset or a pushing device (pusher). The handover devices 18 can be used to hand over articles coming from the third conveying system 19 to the picking stations 17 in a targeted manner.

The control system 20 can comprise other components in addition to the control computer 21, for example radio links between the control computer 21 and the actuators provided in the picking system 1a, i.e. for example radio links between the control computer 21 and the retrieval conveying system 4, the first sorting device 6a, the first conveying system 10, the second sorting device 11, the second conveying system 15, the picking area 16 and the third conveying system 19, as symbolically indicated in FIG. 1. For the communication between the control computer 21 and said units, also data lines can be provided alternatively or additionally to the radio links.

The functioning of the picking system la represented in FIG. 1 is as follows:

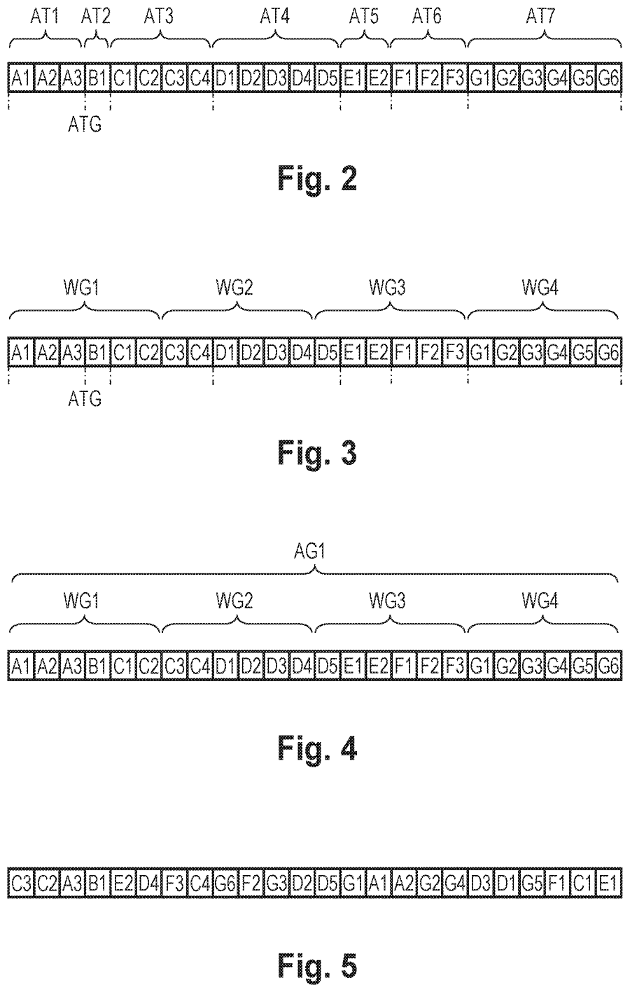

In a step a), multiple orders, each of which comprises at least one article, are acquired in the control computer 21. In an example illustrated by means of FIG. 2, seven orders AT1 . . . AT7 are acquired. The order AT1 comprises the articles A1 . . . A3, the order AT2 comprises the article B1, the order AT3 comprises the articles C1 . . . C4, the order AT4 comprises the articles D1 . . . D5, the order AT5 comprises the articles E1 . . . E2, the order AT6 comprises the articles F1 . . . F3 and the order AT7 comprises the articles G1 . . . G6. Within the meaning of this disclosure, an “order” can be assigned, for example, to a customer and therefore form a “customer order.” The articles of this customer order may occupy one dispatch loading aid, multiple dispatch loading aids or also only a part of a dispatch loading aid (for example when articles of multiple customer orders are combined on a pallet in the picking area 16). Yet, an “order” can also be assigned to a dispatch loading aid and therefore comprise articles which are to be loaded into or onto this dispatch loading aid. Such an order can comprise articles of one or multiple customers.

In a step b), an order sequence of the orders AT1 . . . AT7 desired in the picking area 16 and optionally an article sequence of the articles A1 . . . G6 desired in the picking area 16 is formed within each order AT1 . . . AT7 of the orders AT1 . . . AT7 in the control computer 21. The order sequence does not necessarily correspond to the sequence in which the orders AT1 . . . AT7 are acquired in step a) but can be determined according to the priority of the orders AT1 . . . AT7 or on the basis of a point in time at which an order AT1 . . . AT7 must be completed (i.e. for example on the basis of a delivery date). For example, in step a), the orders AT1 . . . AT7 represented in FIG. 2 may have been received in the sequence AT3, AT7, AT1, AT4, AT5, AT2, AT6 and are to arrive in the picking area 16 in the sequence AT1, AT2, AT3, AT4, AT5, AT6, AT7 represented in FIG. 2.

In a step c), an overall article sequence is formed in the control computer 21 by lining up the orders AT1 . . . AT7 in accordance with the desired order sequence. This overall article sequence can also be seen in FIG. 2.

In a step d), the overall article sequence is segmented into article groups WG1 . . . WG4 with a specifiable number of articles A1 . . . G6 each, independent of order boundaries ATG, in the control computer 21 and a group sequence of the article groups WG1 . . . WG4 according to the overall article sequence is formed in the control computer 21. Here, the number of the articles A1 . . . G6 in an article group WG1 . . . WG4 corresponds to maximally the number of the articles A1 . . . G6 which can be brought into a and/or any sequence in one sorting operation in the second sorting device 11. In this example, a maximum of six articles A1 . . . G6 can be brought into any sequence in one sorting operation in the second sorting device 11 (in this context, see also FIGS. 9 and 10).

Preferably, each article group WG1 . . . WG4 comprises the same number of articles A1 . . . G6 and the number of articles A1 . . . G6 in an article group WG1 . . . WG4 preferably corresponds to precisely the number of articles A1 . . . G6 which can be brought into a and/or any sequence in one sorting operation in the second sorting device 11 (which is six articles A1 . . . G6 in the present example). Accordingly, each of the article groups WG1 . . . WG4 comprises six articles A1 . . . G6 in the example represented in FIG. 3. The article group WG1 comprises specifically the articles A1 . . . C2, the article group WG2 the articles C3 . . . D4, the article group WG3 the articles D5 . . . F3 and the article group WG4 the articles G1 . . . G6.

Evidently, also second sorting devices 11 are conceivable, which can bring another number of articles A1 . . . G6 into any sequence in one sorting operation. Further, it is conceivable that article groups WG1 . . . WG4 comprise different numbers of articles A1 . . . G6. If the second sorting device 11 has a maximum sorting capacity of ten articles A1 . . . G6, the article group WG1 may comprise, for example, the nine articles A1 . . . D1, the article group WG12 the four articles D3 . . . E1, the article group WG3 the five articles E2 . . . G1 and the article group WG4 the five articles G2 . . . G6.

As is apparent from FIG. 3, the article groups WG1 . . . WG4 are formed independent of the order boundaries ATG which form the boundaries between respectively two of the orders AT1 . . . AT7. This means that the boundaries between the article groups WG1 . . . WG4 have no relation whatsoever to the order boundaries ATG.

In another step e), a retrieval group AG1 is formed in the control computer 21, which comprises article groups WG1 . . . WG4 of the group sequence sorted in ascending order for whose articles A1 . . . G6 free capacity in the first sorting device 6a will be available upon a handover into the first sorting device 6a. In the state represented in FIG. 1, the first sorting device 6a is empty. It is advantageous if the retrieval group AG1 comprises as many article groups WG1 . . . WG4 for whose articles A1 . . . G6 free capacity in the first sorting device 6a will be available upon a handover into the first sorting device 6a. In the example illustrated in FIG. 4, the retrieval group AG1 accordingly comprises the article groups WG1 . . . WG4.

The forming of a retrieval group AG1 can generally be executed in step e) once corresponding capacity is currently available in the first sorting device 6a or also in a predictive and/or proactive manner if corresponding capacity will (presumably) be available in the first sorting device 6a upon a handover of the articles A1 . . . G6 of the retrieval group AG1 into the first sorting device 6a.

In a step f), the articles A1 . . . G6 comprised by the retrieval group AG1 are retrieved from the storage area 2 using the retrieval conveying system 4. To that end, the control computer 21 sends a corresponding command to the retrieval conveying system 4. It is conceivable that the retrieval conveying system 4 executes the command autonomously, i.e. retrieves the articles A1 . . . G6 autonomously and without further assistance by the control computer 21. Yet, it would also be conceivable that the retrieval operation is not only initiated but also actively controlled by the control computer 21.

In a step g), the articles A1 . . . G6 comprised by the retrieval group AGI are conveyed to the first sorting device 6a using the first conveying system 10. To that end, the control computer 21 sends a corresponding command to the first conveying system 10. It is conceivable that the first conveying system 10 executes the command autonomously, i.e. conveys the articles A1 . . . G6 autonomously and without further assistance by the control computer 21. Yet, it would also be conceivable that the conveyance of articles is not only initiated but also actively controlled by the control computer 21.

The retrieval of the articles A1 . . . G6 comprised by the retrieval group AG1 can in particular be executed in chaotic sequence, as illustrated in FIG. 5. The retrieval performance of the retrieval conveying system 4 can thereby be optimized, for example when the articles A1 . . . G6 are lined up with regard to a time-optimized or route-optimized operation of the retrieval conveying system 4. FIG. 5 shows the sequence of the articles A1 . . . G6 at a point P1 on the first conveying system 10. As is readily apparent from FIG. 5, the articles A1 . . . G6 pass the point P1 in no particular but in chaotic sequence.

In another step h), the articles A1 . . . G6 of the retrieval group AG1 are selectively handed over from the first conveying system 10 onto the buffer conveyor lines 7 using the input-side handover devices 8. To that end, the control computer 21 sends corresponding commands to the handover devices 8. It is conceivable that the handover devices 8 execute the commands autonomously, i.e. hand over the articles A1 . . . G6 selectively from the first conveying system 10 onto the buffer conveyor lines 7 autonomously and without further assistance by the control computer 21. Yet, it would also be conceivable that the handover of articles is not only initiated but also actively controlled by the control computer 21.

Here, articles A1 . . . G6 of an article group WG1 . . . WG4 of the retrieval group AG1 are handed over into a vacant buffer area onto at least one of the buffer conveyor lines 7, wherein the articles A1 . . . G6 of the article group WG1 . . . WG4 are arranged directly adjacent to one another in any sequence in the at least one buffer conveyor line 7. The articles A1 . . . G6 are conveyed downstream on the buffer conveyor lines 7. To that end, the control computer 21 sends corresponding commands to the buffer conveyor lines 7. It is conceivable that the buffer conveyor lines 7 execute the commands autonomously, i.e. convey the articles A1 . . . G6 autonomously and without further assistance by the control computer 21. Yet, it would also be conceivable that the conveyance of articles is not only initiated but also actively controlled by the control computer 21.

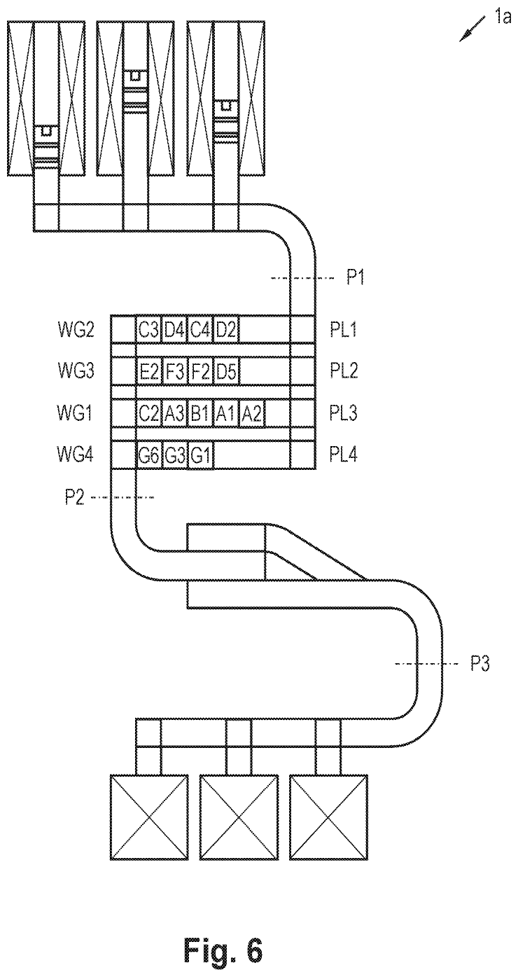

In this context, FIG. 6 shows the picking system 1a from FIG. 1 in a state in which some of the articles, namely the articles A1, A2, A3, B1, C2, C3, C4, D2, D4, D5, E2, F2, F3, G1, G3 and G6, have already been handed over onto the buffer conveyor lines 7 while some of the articles, namely the articles C1, D1, D3, E1, F1, G2, G4 and G5, are still pending. For reasons of better clarity, the individual components of the picking system la already designated in FIG. 1 are not designated again. In addition, the buffer conveyor lines 7 in FIG. 6 and the following figures are designated using their numbering PL1 . . . PL4.

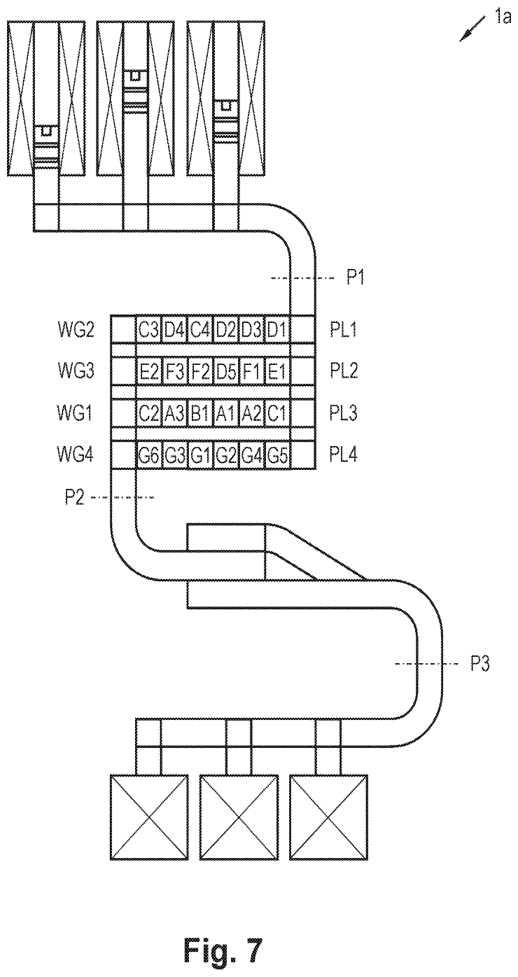

In the example represented in FIG. 6, the article group WG1 is stored in the buffer conveyor line PL3, the article group WG2 in the buffer conveyor line PL1, the article group WG3 in the buffer conveyor line PL2 and the article group WG4 in the buffer conveyor line PL4. A particular assignment between an article group WG1 . . . WG4 and a buffer conveyor line PL1 . . . PL4 is not required. This means that the article groups WG1 . . . WG4 can be handed over onto one of the vacant buffer conveyor lines PL1 . . . PL4 completely randomly. A particular assignment between an article group WG1 . . . WG4 and a buffer conveyor line PL1 . . . PL4 may, however, be required in an alternative embodiment. FIG. 7 shows the picking system 1a from FIG. 1 finally in a state in which all articles A1 . . . G6 have been handed over onto the buffer conveyor lines PL1 . . . PL4.

In a step i), the articles A1 . . . G6 of the article groups WG1 . . . WG4 handed over to the buffer conveyor lines PL1 . . . PL4 are handed over from the buffer conveyor lines PL1 . . . PL4 to the second conveying system 15 in the group sequence using the output-side handover devices 9. To that end, the control computer 21 sends corresponding commands to the handover devices 9. It is conceivable that the handover devices 9 execute the commands autonomously, i.e. hand over the articles A1 . . . G6 autonomously and without further assistance by the control computer 21 from the buffer conveyor lines 7 onto the second conveying system 15. Yet, it would also be conceivable that the handover of articles is not only initiated but also actively controlled by the control computer 21.

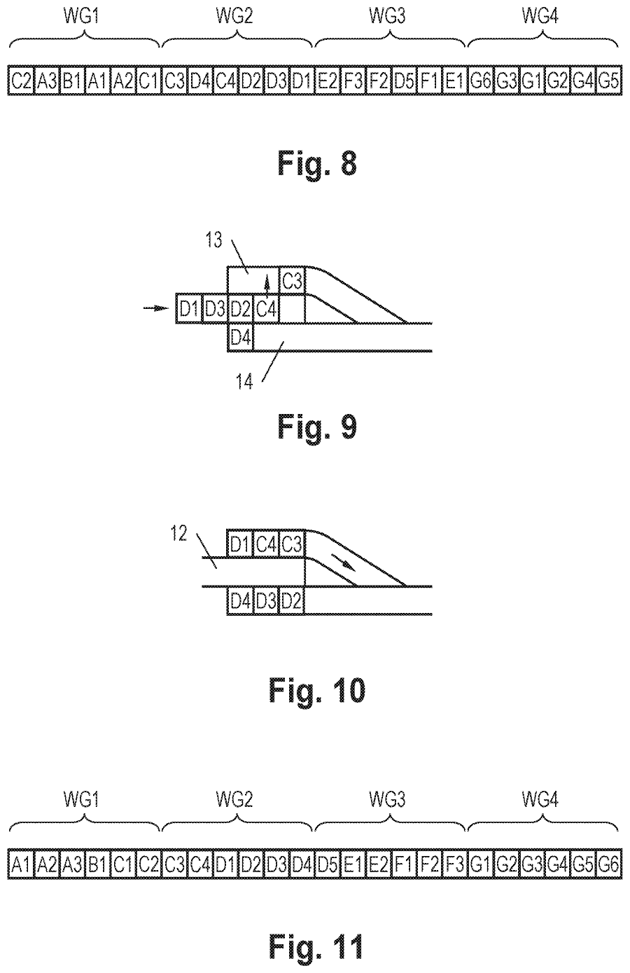

FIG. 8 shows the sequence of the articles A1 . . . G6 at a point P2 on the second conveying system 15. As is readily apparent from FIG. 8, the articles A1 . . . G6 of the article groups WG1 . . . WG4 pass the point P2 in the group sequence. Yet, there is no particular sequence of the articles A1 . . . G6 within the article groups WG1 . . . WG4, i.e. within the article groups WG1 . . . WG4, the articles A1 . . . G6 are in chaotic sequence. Specifically, the articles A1 . . . G6 within an article group WG1 . . . WG4 are in the (chaotic) sequence in which they were retrieved from the storage area 2.

In a step j), the articles A1 . . . G6 of the article groups WG1 . . . WG4 are transported to the second sorting device 11 in the group sequence using the second conveying system 15. To that end, the control computer 21 sends a corresponding command to the second conveying system 15. It is conceivable that the second conveying system 15 executes the command autonomously, i.e. conveys the articles A1 . . . G6 autonomously and without further assistance by the control computer 21. Yet, it would also be conceivable that the conveyance of articles is not only initiated but also actively controlled by the control computer 21.

In a step k), the articles A1 . . . G6 are sorted in the second sorting device 11 groupwise, article group WG1 . . . WG4 by article group WG1 . . . WG4, according to the order sequence. This means that the articles A1 . . . C2 of the article group WG1 are sorted in a first sorting operation, the articles C3 . . . D4 of the article group WG2 in a second sorting operation, the articles D5 . . . F3 of the article group WG3 in a third sorting operation and the articles G1 . . . G6 of the article group WG4 in a fourth sorting operation.

FIGS. 9 and 10 illustrate the sorting operation in the second sorting device 11 using the second article group WG2 as an example. In the state represented in FIG. 9, the article C3 has already been handed over from the central supply conveyor 12 onto the removal conveyor 13 and the article D4 has already been handed over from the central supply conveyor 12 onto the removal conveyor 14. In FIG. 9, the article C4 is just being handed over from the central supply conveyor 12 onto the removal conveyor 13. FIG. 10 shows a state in which the articles C3, C4, D1 have been handed over onto the removal conveyor 13 and the articles D2, D3, D4 onto the removal conveyor 14. Subsequently, the articles C3, C4, D1 are handed over from the removal conveyor 13 onto the third conveying system 19, then the articles D2, D3, D4.

For the sorting operation, the control computer 21 sends a corresponding command to the second sorting device 11. It is conceivable that the second sorting device 11 executes the command autonomously, i.e. sorts the articles C3 . . . D4 autonomously and without further assistance by the control computer 21. Yet, it would also be conceivable that the sorting operation is not only initiated but also actively controlled by the control computer 21.

In another step l), the articles A1 . . . G6 are transported from the second sorting device 11 into the picking area 16 in the order sequence using the third conveying system 19. To that end, the control computer 21 sends a corresponding command to the third conveying system 19. It is conceivable that the third conveying system 19 executes the command autonomously, i.e. conveys the articles A1 . . . G6 autonomously and without further assistance by the control computer 21. Yet, it would also be conceivable that the conveyance of articles is not only initiated but also actively controlled by the control computer 21.

FIG. 11 shows the sequence of the articles A1 . . . G6 at a point P3 on the third conveying system 19. As is readily apparent from FIG. 11, the articles A1 . . . G6 pass the point P3 in the overall article sequence specified in step c) and represented in FIGS. 2 to 4. This means that the articles A1 . . . G6 reach the picking area 16 in the order sequence of the orders AT1 . . . AT7 desired in step b) and the desired article sequence of the articles A1 . . . G6.

In step m), the articles A1 . . . G6 are finally reloaded into or onto target loading aids in the picking area 16 in accordance with the acquired orders AT1 . . . A7. To that end, the control computer 21 sends, on the one hand, corresponding commands to the handover devices 18, so that the articles A1 . . . G6 are handed over to a desired picking station 17. For example, the articles A1 . . . A3 of the order AT1 and the article B1 of the order AT2 can be handed over to the left-hand one of the picking stations 17, the articles C1 . . . C4 of the order AT3, the articles D1 . . . D5 of the order AT4 and the articles E1 . . . E2 of the order AT5 to the middle one of the picking stations 17 and the articles F1 . . . F3 of the order AT6 and the articles G1 . . . G6 of the order AT7 to the right-hand picking station 17 of the picking stations 17. It is conceivable that the handover devices 18 execute the commands autonomously, i.e. hand over the articles A1 . . . G6 autonomously and without further assistance by the control computer 21 selectively from the third conveying system 19 to the picking stations 17. Yet, it would also be conceivable that the handover of articles is not only initiated but also actively controlled by the control computer 21.

The reloading of the articles A1 . . . G6 into or onto target loading aids in step m) can be executed manually or automatically with a loading system. Generally, in step m), one or multiple target loading aids, e.g. one or multiple dispatch loading aids, can be provided per order. In case of manual reloading, it can be displayed, in particular on a screen, which article A1 . . . G6 is to be loaded into which target loading aid. For the reloading, the control computer 21 sends corresponding commands to the picking station 17. It is conceivable that the picking stations 17 execute the commands autonomously, i.e. that the reloading is executed autonomously and without further assistance by the control computer 21. Yet, it would also be conceivable that the reloading is not only initiated but also actively controlled by the control computer 21.

The operations and/or procedures specified in steps a) to m) can in particular be executed continuously and/or repeatedly.

For example, orders AT1 . . . AT7 can be acquired continuously (step a), order sequences and article sequences can be formed continuously (step b), overall article sequences can be formed continuously (step c), article groups WG1 . . . WG4 and group sequences can be formed continuously (step d), retrieval groups AG1 can be formed continuously (step e), articles A1 . . . A6 can be retrieved continuously (step f), articles A1 . . . A6 can be conveyed to the first sorting device 6a continuously (step g), articles A1 . . . A6 can be handed over onto the buffer conveyor lines 7 continuously (step h), articles A1 . . . A6 can be handed over to the second conveying system 15 continuously (step i), articles A1 . . . A6 can be transported to the second sorting device 11 continuously (step j), articles A1 . . . A6 can be sorted in the second sorting device 11 continuously (step k), articles A1 . . . A6 can be transported to the picking area 16 continuously (step l) and articles A1 . . . A6 can be reloaded continuously (step m).

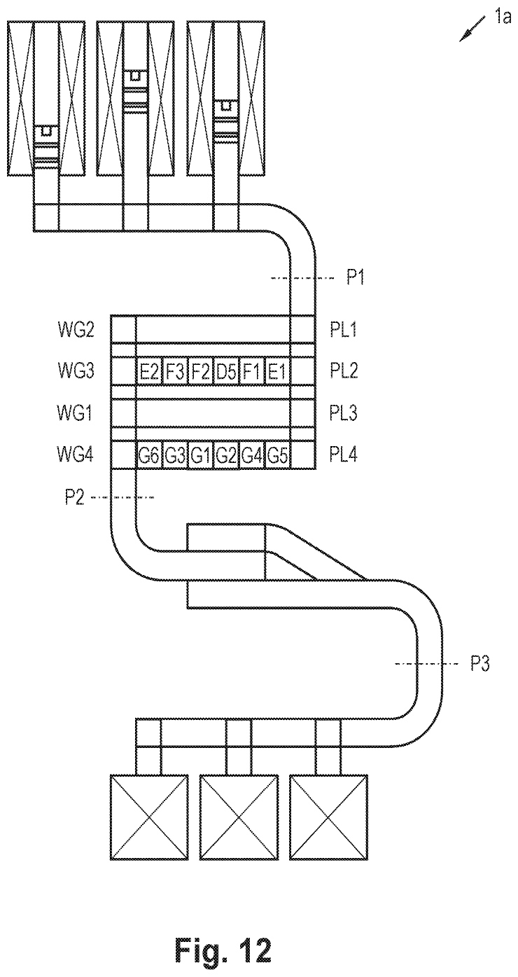

In this context, FIG. 12 shows a state of the picking system 1a represented in FIG. 1 in which the articles A1 . . . C2 of the article group WG1 and the articles C3 . . . D4 of the article group WG2 have already left the first sorting device 6a, and the buffer conveyor lines PL1 and PL3 are accordingly vacant again.

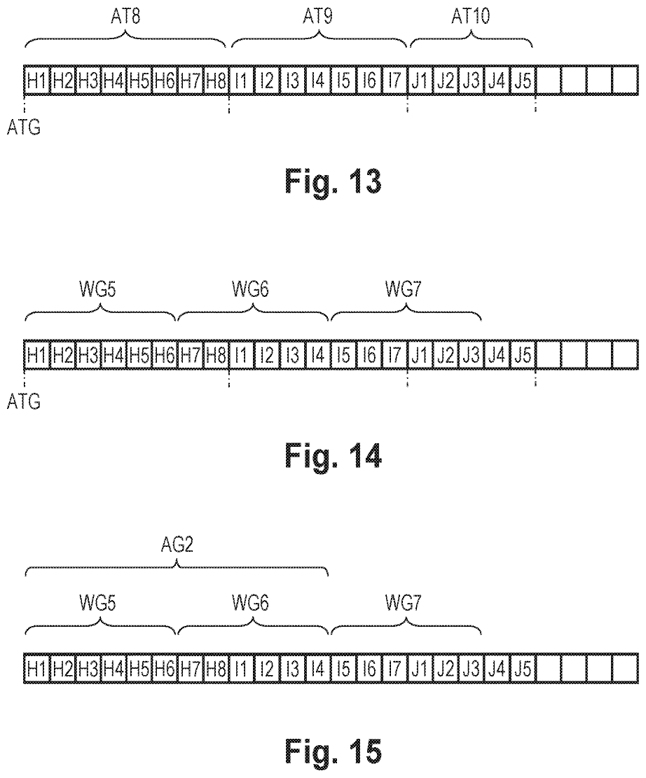

Further, it is assumed that other orders AT8 . . . A10 have meanwhile been acquired (step a), as illustrated in FIG. 13. Here, the order AT8 comprises the articles H1 . . . H8, the order AT9 the articles I1 . . . I7 and the order AT10 the articles J1 . . . J5. In the manner already set forth, steps b) and c) are executed for the newly arrived orders AT8 . . . A10. In this context, FIG. 13 shows the overall article sequence thus obtained. Further, also step d) is executed for the newly arrived orders AT8 . . . A10 in the manner already described. In this context, FIG. 14 shows the article groups WG5 . . . WG7 thus obtained. It is apparent from FIG. 14 that not all articles H1 . . . J5 are comprised by the article groups WG5 . . . WG7, but the two articles J4 . . . J5 remain. These are only taken into consideration during a new forming of article groups. FIG. 15 shows the result of another execution of step e) and thus specifically a second retrieval group AG2.

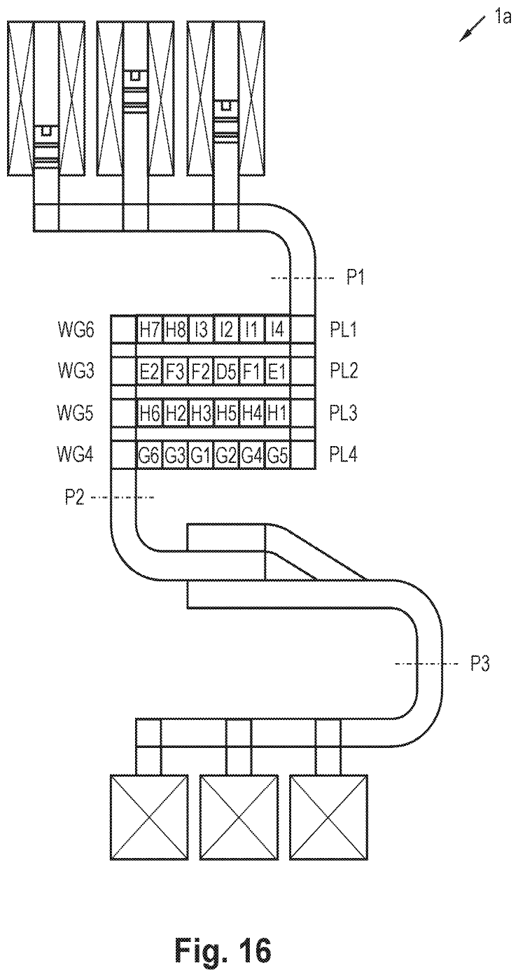

After a new execution of steps f), g) and h), the state represented in FIG. 16 may occur. Specifically, the articles H1 . . . H6 of the article group WG5 were handed over onto the buffer conveyor line PL3 and the articles H7 . . . I4 of the article group WG6 onto the buffer conveyor line PL1. The article groups WG3 and WG4 are also still in the region of the first sorting device 6a, yet they could meanwhile also have left same.

Steps i) to m) are also executed in the manner already described.

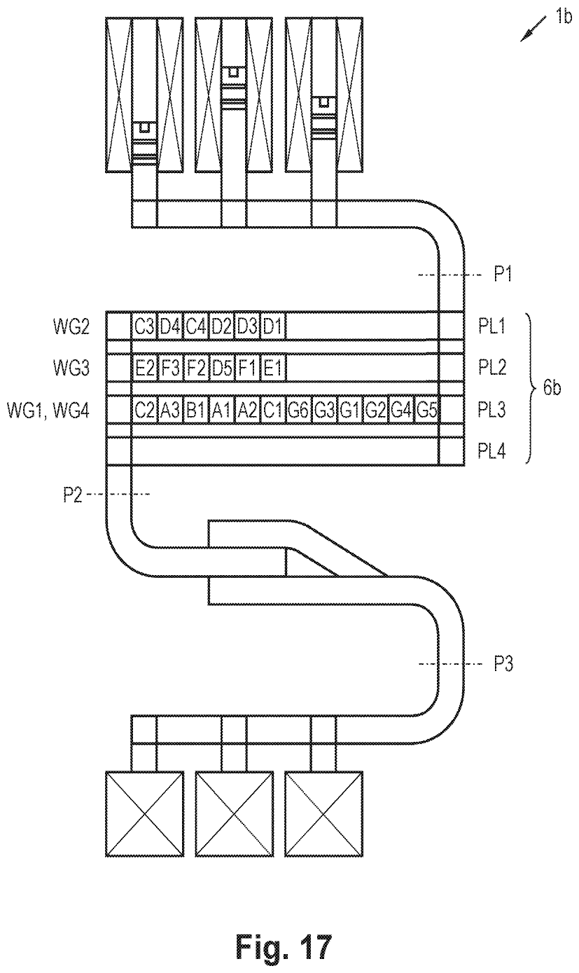

FIG. 17 shows another embodiment variant of a picking system 1b, which is very similar to the picking system 1a represented in FIG. 1. In contrast to the latter, the buffer conveyor lines PL1 . . . PL4 of the first sorting device 6b are configured longer here, in particular twice as long as the buffer conveyor lines PL1 . . . PL4 of the first sorting device 6a. While each of the buffer conveyor lines PL1 . . . PL4 of the first sorting device 6a receives articles A1 . . . G6 of precisely one article group WG1 . . . WG4, the buffer conveyor lines PL1 . . . PL4 of the first sorting device 6b receive articles A1 . . . G6 of multiple whole article groups WG1 . . . WG4, in the specific example respectively articles A1 . . . G6 of precisely two whole article groups WG1 . . . WG4. In FIG. 17, therefore, the articles C3 . . . D4 of the article group WG2 are received in the buffer conveyor line PL1, the articles D5 . . . F3 of the article group WG3 in the buffer conveyor line PL2 and the articles A1 . . . C2 and G1 . . . G6 of the article groups WG1 and WG4 in the buffer conveyor line PL3. Yet, it would also be conceivable that buffer conveyor lines PL1 . . . PL4 are provided which receive articles A1 . . . G6 of a different number of whole article groups WG1 . . . WG4, for example respectively articles A1 . . . G6 of three, four or more whole article groups WG1 . . . WG4.

Steps a) to d), g) and i) to m) are executed analogously to the procedure already described by reference to the FIGS. 2 to 5 and 8 to 11. Merely steps e), f) and h) are different.

Also in step h), articles A1 . . . G6 of the retrieval group AG1 are handed over selectively from the first conveying system 10 onto the buffer conveyor lines PL1 . . . PL4 using the input-side handover devices 8 again, wherein articles A1 . . . G6 of an article group WG1 . . . WG4 of the retrieval group AG1 are handed over into a vacant buffer area on the buffer conveyor lines PL1 . . . PL4 and wherein the articles A1 . . . G6 of this article group WG1 . . . WG4 are arranged directly adjacent to one another in any sequence in the at least one buffer conveyor line PL1 . . . PL4. However, the articles A1 . . . C2 of the article group WG1 and the articles G1 . . . G6 of the article group WG4 are not located next to one another on the buffer conveyor lines PL3 and PL4, as is the case in the example represented in FIG. 7, but in succession in the buffer conveyor line PL3. The buffer conveyor line PL4, in contrast, is still vacant in the state represented in FIG. 17.

The article groups WG1 . . . WG4 have an ordinal number corresponding to the group sequence, wherein articles A1 . . . G6 of article groups WG1 . . . WG4 with a lower ordinal number are stored further downstream in the respective buffer conveyor line PL1 . . . PL4 than articles A1 . . . G6 of article groups WG1 . . . WG4 with a higher ordinal number. In the example represented in FIG. 17, this means that the articles A1 . . . C2 of the article group WG1 are stored further downstream than the articles G1 . . . G6 of the article group WG4.

The proposed measures ensure that a demanded form factor for the first sorting device 6b is achieved more easily. In addition, a constant flow of conveyed articles at the output of the first sorting device 6b can be upheld even if a conveyance of additional articles A1 . . . G6 into the first sorting device 6b takes a relatively long time.

In a first subvariant, the retrieval of the articles A1 . . . G6 comprised by the retrieval group AG1 in step f) is executed in chaotic sequence, wherein articles A1 . . . G6 of article groups WG1 . . . WG4 which are handed over to a buffer conveyor line PL1 . . . PL4 in succession in step h), however, are retrieved without violating the group sequence and/or in accordance with the group sequence. In this variant, the principle of the chaotic retrieval is broken in that article groups WG1 . . . WG4 which are located in a buffer conveyor line PL1 . . . PL4 in succession can be retrieved without violating the group sequence. Otherwise, the chaotic retrieval principle will take effect. In the specific example, this means that the (all) articles A1 . . . C2 of the article group WG1 are retrieved before the (all) articles G1 . . . G6 of the article group WG4 but that there is no restriction of the chaotic retrieval other than this condition.

In a second subvariant, the retrieval of the articles A1 . . . G6 comprised by the retrieval group AG1 in step f) is executed in chaotic sequence, wherein a retrieval group AG1 in step e) has maximally (in particular precisely) as many article groups WG1 . . . WG4 as buffer conveyor lines PL1 . . . PL4 will have free capacity for receiving articles A1 . . . G6 of one article group WG1 . . . WG4 each upon a handover of the articles A1 . . . G6 of the retrieval group AG1 into the first sorting device 6b. Here, it is avoided a priori that a retrieval group AG1 has article groups WG1 . . . WG4 which are handed over in succession to a single buffer conveyor line PL1 . . . PL4. Therefore, the articles A1 . . . G6 of the retrieval group AG1 can be retrieved chaotically without restriction in this case in step f), although a buffer conveyor line PL1 . . . PL4 can receive articles A1 . . . G6 of multiple article groups WG1 . . . WG4.

In the specific example, this means that the articles A1 . . . C2 of the article group WG1 and the articles G1 . . . G6 of the article group WG4 can be stored in the buffer conveyor line PL3 in succession, as represented in FIG. 17, if they are retrieved in succession in step f). If this is not the case because, for example, the article G6 was retrieved before the article C1, the articles G1 . . . G6 of the article group WG4 can be stored in the buffer conveyor line PL4 in deviation from the case represented in FIG. 17. This then basically constitutes the state already represented in FIG. 7.

An initial filling of the first sorting device 6b can be executed gradually by multiple retrieval groups AG1, AG2. In particular, precisely as many retrieval groups AG1, AG2 can be provided as article groups WG1 . . . WG7 can be received in a buffer conveyor line PL1 . . . PL4. In the present example, this means that the articles H1 . . . J3 of the article groups WG5 . . . WG7 can already be handed over into the first sorting device 6b, even if none of the article groups WG1 . . . WG4 have left the first sorting device 6b again yet, since the first sorting device 6b in this example has a receiving capacity of eight article groups WG1 . . . WG7 after all. In particular, the retrieval group AG1 can be formed with the article groups WG1 . . . WG4 and subsequently, as above, the retrieval group AG2 with the article groups WG5 . . . WG6. Yet, in this case, the retrieval group AG2 could also comprise the article group WG7, as well as an eighth article group.

If the procedure is that of the first subvariant, the first sorting device 6b can also be filled with a single retrieval group AG1 which comprises the article groups WG1 . . . WG7, as well as an eighth article group.

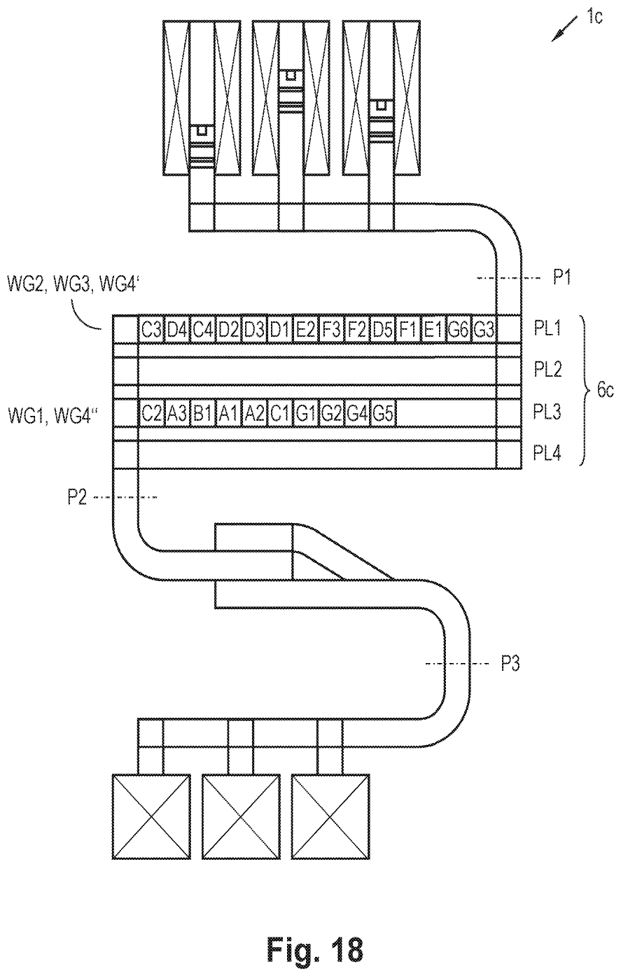

FIG. 18 shows another embodiment variant of a picking system 1c, which is very similar to the picking system 1b represented in FIG. 17. Yet in contrast to the latter, the buffer conveyor lines PL1 . . . PL4 of the first sorting device 6c are configured even somewhat longer. In particular, each of the buffer conveyor lines PL1 . . . PL4 of the first sorting device 6c can receive fourteen articles A1 . . . G6. Accordingly, a quotient of an article capacity of a buffer conveyor line PL1 . . . PL4 of the buffer conveyor lines PL1 . . . PL4 and the number of the articles A1 . . . G6 in an article group WG1 . . . WG7 is not integral. In the specific example, said quotient is 14/6=2.33.

The technical teaching disclosed in relation to the example explained by reference to FIG. 17 can analogously also be applied to the embodiment represented in FIG. 18. In the specific example, the articles C3 . . . D4 of the article group WG2 and the articles D5 . . . F3 of the article group WG3 are stored in the buffer conveyor line PL1 and the articles A1 . . . C2 of the article group WG1 in the buffer conveyor line PL3. The articles G1 . . . G6 of the article group WG4, in contrast, are stored in a “scattered” manner in vacant regions of multiple of the buffer conveyor lines PL1 . . . PL4, namely in vacant regions of the buffer conveyor lines PL1 and PL3. Specifically, the articles G3, G6 of a first article group part WG4′ are located in the buffer conveyor line PL1 and the articles G1, G2, G4, G5 of a second article group part WG4″ in the buffer conveyor line PL3. In step i), it should therefore be noted that the article group WG4 is formed by controlling two buffer conveyor lines PL1 and PL3, wherein it is no matter whether the articles G3, G6 are retrieved from the buffer conveyor line PL1 and then the articles G1, G2, G4, G5 from the buffer conveyor line PL3 or vice versa, since the articles G1 . . . G6 of the article group WG4 in the second sorting device 11 can be brought into the correct sequence again anyway.

In the preceding examples, it was assumed that, in addition to an order sequence of the orders AT1 . . . AT7 desired in the picking area 16, an article sequence of the articles A1 . . . G6 desired in the picking area 16 is formed within each order AT1 . . . AT7 of the orders AT1 . . . AT7 in the control computer 21 in step b).

This means that:
an overall article sequence desired in the picking area 16 is formed by lining up the orders AT1 . . . AT7 in step c),
the overall article sequence is produced by sorting the articles A1 . . . G6 groupwise, article group WG1 . . . WG4 by article group WG1 . . . WG4, in the second sorting device 11 in step k), and
the articles A1 . . . G6 are transported into the picking area 16 in the overall article sequence with the third conveying system 19 in step l).

However, this is not imperatively required. Rather, it is conceivable that the article sequence of the articles A1 . . . G6 within each order AT1 . . . AT7 need not correspond to the article sequence of the articles A1 . . . G6 desired in the picking area 16, but the articles A1 . . . G6 of an order AT1 . . . AT7 can arrive there in any, i.e. in a random, sequence.

Whereas the grouping, at least order by order, of the articles A1 . . . G6 according to the order sequence in step h) is executed implicitly by producing the desired overall article sequence and an explicit step for grouping the articles A1 . . . G6 order by order according to the order sequence was not required to that end in the preceding examples, the focus in step h) is (only) on the order-by-order grouping of the articles A1 . . . G6 according to the order sequence.

With respect to sorting the article group WG2 (see also FIGS. 9 and 10), this means that, while the articles C3, C4 of the order AT3 must leave the second sorting device 11 before the articles D1 . . . D4 of the order AT4, any sequence can be provided and/or permitted within the orders AT3, AT4. It is also conceivable, for example, that the articles C3, C4 of the article group WG2 leave the second sorting device 11 in the sequence C4, C3, D3, D4, D1, D2. In particular, a sequence (see also FIG. 8) existing within the orders AT3, AT4 after the chaotic retrieval in step f) can simply be maintained. Accordingly, the articles C3 . . . D4 of the article group WG2 can leave the second sorting device 11 in particular in the sequence C3, C4, D4, D2, D3, D1. On the basis of the state in FIG. 8, the sequence of the articles D4, C4, therefore, need only be switched.

Article groups WG1 . . . WG7, each of which contains articles A1 . . . J5 of only one order AT1 . . . AT10, can pass through the second sorting device 11 in step k) without any sorting operation or avoid it via a bypass, since a sorting of the articles A1 . . . J5 within an order AT1 . . . AT10 is not required in the presently described embodiment variant. In the present examples, this applies to the article groups WG4 and WG5.

If articles G1 . . . G6 of the article group WG4 or articles H1 . . . H6 of the article group WG5 pass through the second sorting device 11 without sorting operation, they can simply be dispensed in succession from the central supply conveyor 12 onto one of the removal conveyors 13 and 14. It would also be conceivable that the central supply conveyor 12 is directly connected to the third conveying system 19. A dispensing of the articles G1 . . . G6 and H1 . . . H6 onto the removal conveyors 13 and 14 will then be obsolete.

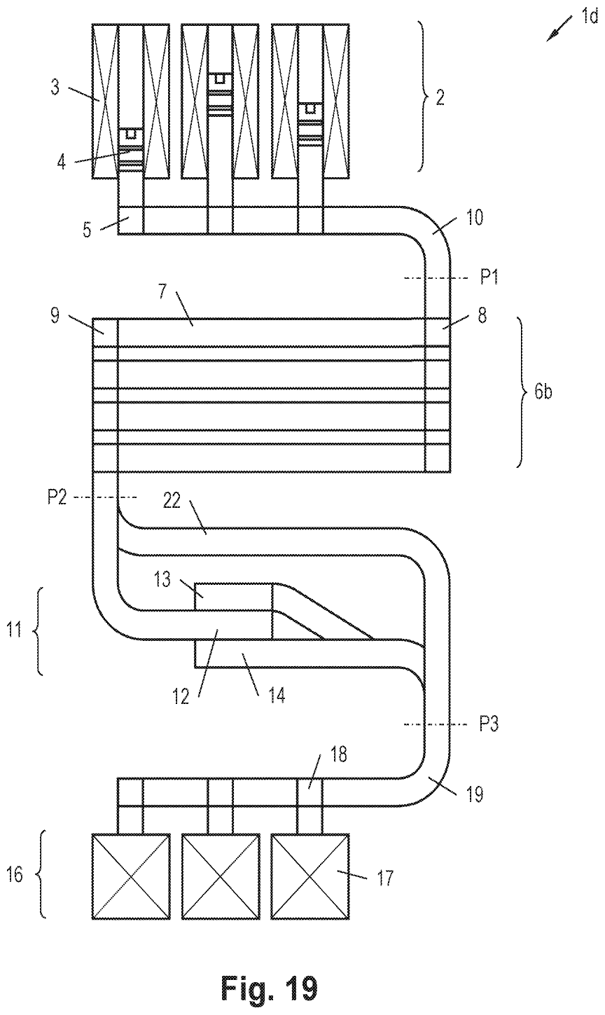

It is also conceivable that a bypass 22 is provided which avoids the second sorting device 11, as is the case in the example of a picking system 1d represented in FIG. 19. The article groups WG4 and WG5, each of which contains articles G1 . . . G6 and H1 . . . H6 of only one order AT7 and AT8, can avoid the second sorting device 11 in step k) using the bypass 22. Such a bypass 22 can also be provided in the picking system 1a . . . 1c represented in FIG. 1, FIG. 17 and FIG. 18.

In the examples disclosed thus far, it was assumed that each of the articles A1 . . . J5 consists of a single piece and/or the procedures presented were based on one piece per article A1 . . . J5. Yet, this is not an imperative condition. Rather, it is also conceivable that:
an article A1 . . . J5 in the overall article sequence is any piece of multiple articles A1 . . . J5 of the same type of article which are stored in or on a loading aid,
steps f) to l) are executed by corresponding manipulation of the loading aid, and
step m) comprises the removal of the article A1 . . . J5 from or off the loading aid.

In relation to the examples disclosed thus far, this means, therefore, that, instead of an article A1 . . . J5, also a loading aid with multiple pieces of the respective article A1 . . . J5 can be provided in the examples presented. This means that, for example, instead of the article A1, a loading aid with multiple of these articles Al can be provided, and so on. Yet, this does basically not change the sorting method, in particular when respectively one piece of an article A1 . . . J5 is removed from the respective loading aids. If multiple pieces of an article A1 . . . J5 are required in step m), the method can be simplified in that simply multiple pieces of an article A1 . . . J5 are removed from a loading aid without having to occupy multiple places in the sorting method to that end. If three pieces of an article A1 are required in step m), for example, the article sequence need not contain the sequence A1, A1, A1, A2, A3, . . . but can simply be written as 3×A1, 1×A2, 1×A3, . . . or in a simplified manner as 3×A1, A2, A3, . . . It must merely be ensured that the respective loading aid then contains at least three pieces of the article A and three pieces of the article A are removed from or off the loading aid and reloaded into or onto the target loading aid in step m).

Strictly speaking, this case may be referred to as “type-of-article sequence” instead of “article sequence.” Accordingly, the term “article sequence” in the above disclosure can be mentally replaced with the term “type-of-article sequence.” Also conceivable are mixed forms in which a part of the articles A1 . . . J5 are provided as one piece and manipulated without loading aids and another part of the articles A1 . . . J5 are transported in loading aids. Accordingly, the term “article sequence” in the above disclosure can be mentally replaced with the term “mixed type-of-article and article sequence.”

However, it should be noted that the article sequence in each of the specified cases can have multiple instances, for example of the article A1, if multiple pieces of the article or type of article A1 are required in different picking stations 17 or even in one picking stations 17 at different points in time, for example if multiple pieces of the article or type of article A1 are required and/or provided in different places in a packing pattern for a pallet.

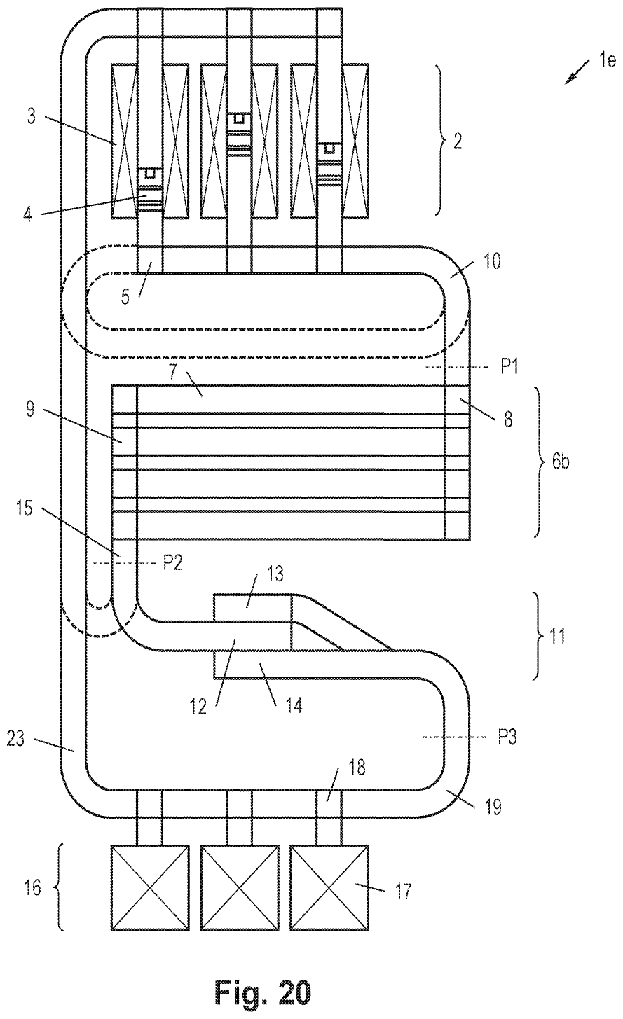

Advantageously, a remaining quantity of articles A1 . . . J5 which remains in or on the loading aid after step m) can be stored in the storage area 2 again. In this context, FIG. 20 shows an embodiment of a picking system 1e, which is similar to the picking system 1b represented in FIG. 17. In contrast to the latter, the picking system 1e comprises a return conveyor 23, via which articles A1 . . . J5 that are not required are stored in the storage area 2 again. In the example represented in FIG. 20, the return conveyor 23 is guided to the back of the storage area 2, so that the retrieval process is not disrupted by articles A1 . . . J5 to be stored again. However, it is also conceivable that the return conveyor 23 leads to the front of the storage area 2, as indicated with dashed lines. Such a return conveyor 23 can also be provided in the picking systems 1a . . . 1d represented in FIG. 1, FIG. 17 to FIG. 19.

It is further conceivable that the first conveying system 10 comprises a circular conveyor, as indicated in FIG. 20 with dashed lines. Further, it is possible, for example, that the second conveying system 15 can also be connected to the return conveyor 23 and/or the circular conveyor of the first conveying system 10, as indicated in FIG. 20 also with dashed lines. The circular conveyor and/or the connection of the second conveying system 15 to the return conveyor 23 enables articles A1 . . . J5 to be returned past the first sorting device 6b or past the second sorting device 11 and in particular also be stored again. This is advantageous, for example, whenever there are disruptions in the procedure of the picking method or, for example, orders AT1 . . . AT10 are canceled or prioritized differently. Evidently, the measures proposed in FIG. 20 can also be combined with the bypass 22 of FIG. 19 and/or be provided in the picking systems 1a . . . 1d represented in FIG. 1, FIG. 17 to FIG. 19.

The fact that the overall article sequence in article groups WG1 . . . WG7 is segmented with respectively any number of articles A1 . . . J5 independent of order boundaries ATG enables the second sorting device 11 to be operated generally optimally, i.e. close to or at the maximum sorting capacity. As already mentioned, this is particularly successful whenever the number of articles A1 . . . J5 in an article group WG1 . . . WG7 corresponds to precisely the number of articles A1 . . . J5 which can be brought into any sequence in one sorting operation in the second sorting device 11. Yet generally, the article groups WG1 . . . WG7 can also comprise fewer articles A1 . . . J5 and the article groups WG1 . . . WG7 can generally also have different sizes. Further, it is pointed out that, while the buffer conveyor lines PL1 . . . PL4 in the examples represented respectively have the same length and can receive the same number of articles A1 . . . J5, this is not an imperative condition for the method presented. Rather, the buffer conveyor lines PL1 . . . PL4 can also have different lengths, for example if this is required for structural design reasons. As mentioned, one or multiple steps f) to m) can be initiated, or even controlled, by the control computer 21. The control of one or multiple of the steps f) to m) can also be taken over by a local subcontroller.

It is of advantage if the articles A1 . . . J5 of an article group WG1 . . . WG7 of the retrieval group AG1, AG2 are respectively stored in a vacant region of precisely one of the buffer conveyor lines PL1 . . . PL4, in particular if the articles A1 . . . J5 of all article groups WG1 . . . WG7 are respectively stored in a vacant region of precisely one of the buffer conveyor lines PL1 . . . PL4, as is the case in the examples represented, with the exception of FIG. 18.

Generally, the sorting in the examples represented in FIGS. 1 to 20 is executed in two stages, with further sorting stages being possible.

Strictly speaking, a presorting in the first sorting stage 6a . . . 6c can only be executed if a retrieval group AG1, AG2 comprises more than one article group WG1 . . . WG7. In particular, it is therefore of advantage if a retrieval group AG1, AG2 comprises more than one article group WG1 . . . WG7.

In the examples, it was implicitly assumed that the articles A1 . . . J5 on the first conveying system 10, on the second conveying system 15 and on the third conveying system 19 are conveyed continuously. Yet it is also conceivable that the articles A1 . . . J5 on the first conveying system 10, on the second conveying system 15 and/or on the third conveying system 19 are conveyed discontinuously and can therefore also be backed up there. The first conveying system 10, the second conveying system 15 and/or the third conveying system 19 can therefore act as a buffer, temporarily or in sections.

Finally, it should be noted that the scope of protection is determined by the claims. However, the description and the drawings are to be adduced for construing the claims. Individual features or feature combinations from the different exemplary embodiments shown and described may represent independent inventive solutions. The object underlying the independent inventive solutions may be gathered from the description.

In particular, it should also be noted the devices depicted may, in reality, also comprise more, or also fewer, components than depicted. In some cases, the shown devices and/or their components may not be depicted to scale and/or be enlarged and/or reduced in size.

### TABLE OF REFERENCE NUMBERS

1a . . . 1e picking system
2 storage area
3 storage rack
4 retrieval conveying system
5 output-side handover device of storage area
6a . . . 6d first sorting device
7 buffer conveyor line
8 input-side handover device of first sorting device
9 output-side handover device of first sorting device
10 first conveying system
11 second sorting device
12 central supply conveyor
13 removal conveyor
14 removal conveyor
15 second conveying system
16 picking area
17 picking station
18 input-side handover device of picking station
19 third conveying system
20 control system
21 control computer
22 bypass
23 return conveyor
A1 . . . J5 article(s)
AG1, AG2 retrieval group
AT1 . . . AT10 order
ATG order boundary
P1 . . . P3 point
PL1 . . . PL4 number of buffer conveyor line
WG1 . . . WG7 article group
WG4′, WG4″ article group part

1. A multi-stage method for automatically sequencing articles in a picking system including:
a storage area, in which articles are stored and which comprises a retrieval conveying system,
a first sorting device, which has multiple buffer conveyor lines which are parallel in terms of conveyance and an input-side handover device assigned per buffer conveyor line and an output-side handover device assigned per buffer conveyor line,
a first conveying system, which connects the storage area and the first sorting device,
a second sorting device, which is arranged downstream of the first sorting device,
a second conveying system, which connects the first sorting device and the second sorting device,
a picking area, which is arranged downstream of the second sorting device,
a third conveying system, which connects the second sorting device and the picking area, and
a control system, which comprises a control computer and which is connected to the first sorting device and second sorting device,
the method comprising the steps:
a) acquiring multiple orders, each of which comprises at least one article, in the control computer,
b) forming an order sequence of the orders desired in the picking area and an article sequence of the articles within each order of the orders in the control computer,
c) forming an overall article sequence by lining up the orders in accordance with the desired order sequence in the control computer,
d) segmenting the overall article sequence into article groups with a specifiable number of articles each, independent of order boundaries, and forming a group sequence of the article groups according to the overall article sequence in the control computer, wherein the number of the articles in an article group corresponds to maximally the number of the articles which can be brought into any sequence in the second sorting device,
e) forming a retrieval group, which comprises article groups of the group sequence sorted in ascending order for whose articles free capacity will be available in the first sorting device upon a handover into the first sorting device, in the control computer,
f) retrieving the articles comprised by the retrieval group from the storage area using the retrieval conveying system,
g) conveying the articles comprised by the retrieval group to the first sorting device using the first conveying system,
h) selectively handing over the articles of the retrieval group from the first conveying system onto the buffer conveyor lines using the input-side handover devices, wherein articles of an article group of the retrieval group are handed over into a vacant buffer area onto at least one of the buffer conveyor lines and wherein the articles of the article group in the at least one buffer conveyor line are arranged directly adjacent to one another in any sequence,
i) handing over the articles of the article groups from the buffer conveyor lines to the second conveying system in the group sequence using the output-side handover devices,
j) transporting the articles of the article groups to the second sorting device in the group sequence using the second conveying system,
k) sorting the articles groupwise, article group by article group, according to the order sequence in the second sorting device,
l) transporting the articles from the second sorting device into the picking area in the order sequence using the third conveying system, and
m) reloading the articles into or onto target loading aids in accordance with the acquired orders in the picking area.

2. The method according to claim 1, wherein the article groups which contain articles of respectively only one order pass through the second sorting device in step k) without a sorting operation or avoid it using a bypass.

3. The method according to claim 1, wherein
an article sequence of the articles desired in the picking area is additionally formed within each order of the orders in the control computer in step b),
an overall article sequence desired in the picking area is formed by lining up the orders in step c),
the overall article sequence is produced by sorting the articles groupwise, article group by article group, in the second sorting device in step k), and
the articles are transported into the picking area in the overall article sequence with the third conveying system in step l).

4. The method according to claim 1, wherein each article group has the same number of articles.

5. The method according to claim 4, wherein the number of articles in an article group corresponds to precisely the number of articles which can be brought into any sequence in the second sorting device.

6. The method according to claim 1, wherein the articles of an article group of the retrieval group are stored in a vacant region of precisely one of the buffer conveyor lines.

7. The method according to claim 6, wherein each of the buffer conveyor lines receives articles of precisely one article group.

8. The method according to claim 7, wherein the retrieval of the articles comprised by the retrieval group in step f) is executed in chaotic sequence.

9. The method according to claim 6, wherein each of the buffer conveyor lines receives articles of multiple whole article groups, wherein the article groups have an ordinal number corresponding to the group sequence and wherein articles of article groups with a lower ordinal number are stored further downstream in the respective buffer line than articles of article groups with a higher ordinal number.

10. The method according to claim 1, wherein the articles of some of the article groups of the retrieval group are stored in vacant regions of multiple of the buffer conveyor lines.

11. The method according to claim 10, wherein a quotient of an article capacity of a buffer conveyor line of the buffer conveyor lines and the number of the articles in an article group is not integral, wherein the article groups have an ordinal number corresponding to the group sequence and wherein articles of article groups with a lower ordinal number are stored further downstream in the respective buffer line than articles of article groups with a higher ordinal number.

12. The method according to claim 9, wherein the retrieval of the articles comprised by the retrieval group in step f) is executed in chaotic sequence, wherein articles of those article groups which are handed over to one of the buffer conveyor lines in succession in step h) are retrieved in accordance with the group sequence.

13. The method according to claim 9, wherein the retrieval of the articles comprised by the retrieval group in step f) is executed in chaotic sequence, wherein a retrieval group in step e) has maximally as many article groups as buffer conveyor lines will have free capacity for receiving articles of one article group each upon a handover of the articles of the retrieval group into the first sorting device.

14. The method according to claim 1, wherein steps f) to m) are initiated by the control computer.

15. The method according to claim 1, wherein one or multiple of the steps f) to m) are controlled by the control computer.

16. The method according to claim 1, wherein:
an article in the overall article sequence is any piece of multiple articles of the same type of article which are stored in or on a loading aid,
steps f) to l) are executed by corresponding manipulation of the loading aid, and
step m) comprises the removal of the article from or off the loading aid.

17. The method according to claim 16, wherein a remaining quantity of articles which remains in or on the loading aid after step m) is stored in the storage area.

18. A picking system including:
a storage area, in which articles are stored and which comprises a retrieval conveying system,
a first sorting device, which has multiple buffer conveyor lines which are parallel in terms of conveyance and an input-side handover device assigned per buffer conveyor line and an output-side handover device assigned per buffer conveyor line,
a first conveying system, which connects the storage area and the first sorting device,
a second sorting device, which is arranged downstream of the first sorting device,
a second conveying system, which connects the first sorting device and the second sorting device,
a picking area, which is arranged downstream of the second sorting device,
a third conveying system, which connects the second sorting device and the picking area, and
a control system, which comprises a control computer and which is connected to the first sorting device and second sorting device, wherein the control computer is configured for:
a) acquiring multiple orders, each of which comprise at least one article,
b) forming an order sequence of the orders desired in the picking area and an article sequence of the articles within each order of the orders,
c) forming an overall article sequence by lining up the orders in accordance with the desired order sequence,
d) segmenting the overall article sequence into article groups with a specifiable number of articles each, independent of order boundaries, and forming a group sequence of the article groups according to the overall article sequence, wherein the number of the articles in an article group corresponds to maximally the number of the articles which can be brought into any sequence in the second sorting device,
e) forming a retrieval group, which comprises article groups of the group sequence sorted in ascending order for whose articles free capacity will be available in the first sorting device upon a handover into the first sorting device,
f) triggering a retrieval of the articles comprised by the retrieval group from the storage area using the retrieval conveying system,
g) triggering a conveyance of the articles comprised by the retrieval group to the first sorting device using the first conveying system,
h) triggering a selective handover of the articles of the retrieval group from the first conveying system onto the buffer conveyor lines using the input-side handover devices, wherein articles of an article group of the retrieval group are handed over into a vacant buffer area onto at least one of the buffer conveyor lines and wherein the articles of the article group in the at least one buffer conveyor line are arranged directly adjacent to one another in any sequence,
i) triggering a handover of the articles of the article groups handed over to the buffer conveyor lines from the buffer conveyor lines to the second conveying system in the group sequence using the output-side handover devices,
j) triggering a transport of the articles of the article groups to the second sorting device in the group sequence using the second conveying system,
k) triggering a groupwise sorting of the articles, article group by article group, according to the order sequence in the second sorting device,
l) triggering a transport of the articles from the second sorting device into the picking area in the order sequence using the third conveying system, and
m) triggering a reloading of the articles into or onto target loading aids in accordance with the acquired orders in the picking area.

19. The picking system according to claim 18, wherein the controller is further configured for controlling one or multiple of the steps f) to m).

20. A multi-stage method for automatically sequencing articles in a picking system comprising:
a storage area, in which articles are stored and which comprises a retrieval conveying system;
a first sorting device, which has multiple buffer conveyor lines which are parallel in terms of conveyance and an input-side handover device assigned per buffer conveyor line and an output-side handover device assigned per buffer conveyor line;
a first conveying system, which connects the storage area and the first sorting device;
a second sorting device, which is arranged downstream of the first sorting device;
a second conveying system, which connects the first sorting device and the second sorting device;
a picking area, which is arranged downstream of the second sorting device;
a third conveying system, which connects the second sorting device and the picking area; and
a control system, which comprises a control computer and which is connected to the first sorting device and second sorting device.
